(19) United States
(12) Patent Application Publication
(10) Pub. No.: US 2018/0057265 A1
(43) Pub. Date: Mar. 1, 2018

(54) OPTIMIZING MOVEMENT OF ROBOTIC DRIVE UNITS

(71) Applicant: Rajesh MANPAT, Bangalore (IN)

(72) Inventor: Rajesh MANPAT, Bangalore (IN)

(73) Assignee: Rajesh MANPAT, Bangalore (IN)

(21) Appl. No.: 15/560,496

(22) PCT Filed: Mar. 23, 2016
(86) PCT No.: PCT/IB2016/051640

§ 371 Date: Sep. 22, 2017

(30) Foreign Application Priority Data
Mar. 23, 2015 (IN) 1477/CHE/2015

(51) Int. Cl. B65G 1/137; G05B 15/02; G05D 1/00; G05D 1/02; B25J 5/00; B65G 1/04

(52) U.S. Cl. CPC B65G 1/1373; G05B 15/02; G05D 1/0027; G05D 1/0214; G06Q 10/087; B25J 5/007; B65G 1/0435; G05D 1/0234; G05D 1/0246

(57) ABSTRACT

Techniques for optimizing movement of robotic drive units (RDUs) in a warehouse are described. The optimization involves assignment of a task of delivery of plurality of products to a destination location a first RDU of a plurality of RDUs in the warehouse. Then, an analysis is performed for each product whether its retrieval is to be assigned to an RDU other than the first RDU. Based on the analysis, a task of retrieval of one or more products is assigned to one or more RDUs other than the first RDU. Further, an intersection point between a future path of the first RDU and a future path of each of the one or more RDUs is determined. Based on the determination, each RDU is instructed to deliver its respective retrieved products at the intersection point. The first RDU is then instructed to retrieve products delivered at intersection points.

### TECHNICAL FIELD

The present subject matter relates, in general, to optimizing movement of robotic drive units (RDUs) and, in particular, to optimizing movement of products using RDUs in a warehouse environment.

### BACKGROUND

Robotic drive units (RDUs) are mobile robotic systems having wheels, motors, guidance sensors, and communication capabilities. The RDUs are used in a wide variety of applications, typically, for storage and retrieval of products. For example, RDUs are used in warehouses, where a huge number of products of various types are stored in, for example racks, shelves, and compartments, for retrieving and storing the products, thereby fulling orders.

### BRIEF DESCRIPTION OF DRAWINGS

The features, aspects, and advantages of the present subject matter will be better understood with regard to the following description, and accompanying figures. The use of the same reference number in different figures indicates similar or identical features and components.

FIG. 1 illustrates a block diagram representation of robotic drive unit (RDU), in accordance with an implementation of the present subject matter.

FIG. 2(a) illustrates an RDU, in accordance with an implementation of the present subject matter.

FIG. 2(b) illustrates a rotary plate in an RDU, in accordance with an implementation of the present subject matter.

FIG. 3 illustrates a three dimensional view of an RDU, in accordance with an implementation of the present subject matter.

FIG. 4(a) illustrates vertical movement of an arm holder of an arm unit, in accordance with an implementation of the present subject matter.

FIG. 4(b) illustrates horizontal movement of arms of RDU, in accordance with an implementation of the present subject matter.

FIG. 5 illustrates navigation of an RDU, in accordance with an implementation of the present subject matter.

FIG. 6 illustrates an example warehouse in which multiple RDUs are used for storage and retrieval operations, in accordance with an implementation of the present subject matter.

FIG. 7 illustrates a schematic representation of a network environment of a warehouse, in accordance with an implementation of the present subject matter.

FIG. 8 illustrate a method 800 utilized by a computing system for optimizing a retrieval operation, in accordance with an implementation of the present subject matter.

FIG. 9 illustrates a network environment 900, in accordance with an implementation of the present subject matter.

FIG. 10 illustrates a method 1000 for utilizing a robotic drive unit (RDU) to deliver a plurality of products to a destination location, in accordance with an implementation of the present subject matter.

### DETAILED DESCRIPTION

The present subject matter relates to systems and methods for optimizing movement of robotic drive units (RDUs).

RDUs are robot based systems that are typically used for moving inventory. An RDU can include at least one motor for moving the RDU, at least one arm controlled by the motor for carrying a product or its container, and guidance sensors coupled to the motor for assisting with the movement of the RDU. The RDU can be equipped with communication capabilities that enable the RDU to be controlled remotely.

The RDUs have found widespread acceptance in warehouses, where thousands of different products may be stored in different sections in, for example, racks, shelves, and the like, for storing and retrieving products. An RDU may be controlled by, for example, a computing system, which can provide instructions to the RDU for retrieving or storing a product. The instructions may be provided by the server in response to an order for which multiple products in disparate locations of the warehouse are to be retrieved or for which multiple products have to be stored in disparate locations of the warehouse. In response to the instructions, the RDU may then go to each location, retrieve the products (in the case of retrieval), collect them, and deliver them in a location to be delivered. Therefore, for catering to a single order, the RDU may have to travel to multiple locations inside the warehouse, which leads to a reduction in the speed of retrieval or storage and also reduction in cost efficiency.

Further, a typical warehouse environment can have multiple RDUs to cater to multiple storage and retrieval orders simultaneously. As explained earlier, each RDU may have to go to multiple locations for retrieving or storing products corresponding to the order they fulfill. At times, multiple RDUs may be at a same location in the warehouse for retrieving products that are placed near each other. Similarly, multiple RDUs may be at a same location in the warehouse for storing products. Thus, traffic at the location may increase, leading to a further decrease in the storage or retrieval speed and throughput of the storage and retrieval operations.

The present subject matter relates to systems and methods for optimizing movement of RDUs. With the methods and systems of the present subject matter, speed of storage and retrieval of products by the RDUs can be significantly improved.

In an implementation of the present subject matter, an order for a plurality of products to be retrieved from a warehouse is received. The warehouse has a plurality of RDUs for fulfilling the order. A first RDU of the plurality of RDUs is assigned a task of delivery of the plurality of products to a destination location. Then, an analysis is performed for each product of the plurality of products whether retrieval of product is to be assigned to an RDU other than the first RDU. The analysis is performed based on one or more conditions. Thereafter a task of retrieval of one or more products is assigned to one or more RDUs other than the first RDU based on the analysis. Further, an intersection point between a future path of the first RDU and a future path of each of the one or more RDUs is determined. Based on the determination, each RDU of the one or more RDUs is instructed to deliver respective retrieved products at the intersection point between its future path and the future path of the first RDU. In addition, the first RDU is instructed to retrieve each product of the one or more products delivered at each intersection point for delivering at the destination location.

Since retrieval of the one or more products is assigned to the one or more RDUs, the first RDU is freed of the task of going to a location of each of the one or more products. Thus, the travel time of the first RDU is significantly reduced. Further, the order is fulfilled at a faster rate. Further, since the first RDU does not have to travel to the locations of each of the one or more products, traffic at the locations of the one or more products is reduced.

The above and other features, aspects, and advantages of the subject matter will be better explained with regard to the following description, appended claims, and accompanying figures.

The above mentioned methods and systems are further described with reference to figures. It should be noted that the description and figures merely illustrate the principles of the present subject matter along with examples described herein and, should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference like features and components.

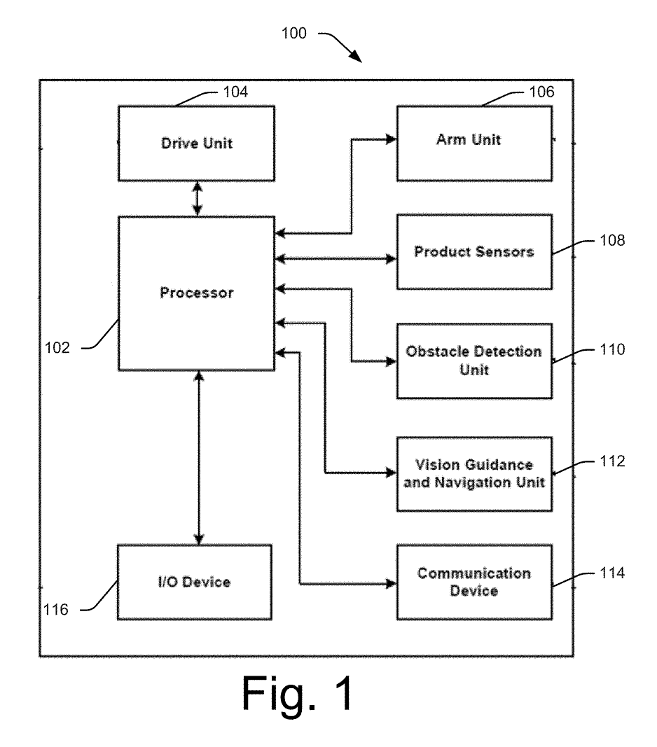

FIG. 1 illustrates a block diagram representation of robotic drive unit (RDU) 100, in accordance with an implementation of the present subject matter. The RDU 100 includes, among other components, processor(s) 102, a drive unit 104, an arm unit 106, product sensors 108, an obstacle detection unit 110, a vision guidance and navigation unit 112, a communication device 114, and I/O (input/output) device 116.

The processor(s) 102 may be implemented as microprocessors, microcomputers, microcontrollers, digital signal processors, central processing units, state machines, logic circuitries, and/or any devices that manipulate signals based on operational instructions. Among other capabilities, the processor(s) 102 may fetch and execute computer-readable instructions stored in a memory. The functions of the processor(s) 102 may be provided through the use of dedicated hardware as well as hardware capable of executing machine readable instructions. The processor(s) 102 operates the RDU 100 based on commands or instructions received from a computing system (not shown in Fig.) and inputs received from the product sensors 108, the obstacle detection unit 110, and the vision guidance and navigation unit 112.

The drive unit 104 moves the RDU 100 to various locations in a warehouse based on commands received by the processor(s)102. The drive unit 104 includes, at a minimum, a motor, a drive wheel and one or more caster wheels. Here, a warehouse refers to any location in which multiple products are stored in various locations and where products are required to be stored and retrieved.

The arm unit 106 includes at least one arm to hold a product and an arm holder to hold the at least one arm. Here, a product may refer to a product and a container in which the product is kept.

The product sensors 108 are used to recognize products that are be stored or retrieved. The recognition can be performed to verify whether a correct product has been stored or retrieved. The product sensors 108 can include, but are not restricted to, barcode readers, RFID scanners, and cameras.

The obstacle detection unit 110 determines whether an object is in a travel path of the RDU 100. If an object is determined to be in the travel path of the RDU 100, the obstacle detection unit 110 can communicate to the processor(s) 102. The obstacle detection unit 110 can include an imaging device, such as a camera, or an ultrasonic sensor. In an implementation, the obstacle detection unit 110 generates a new travel path for the RDU 100.

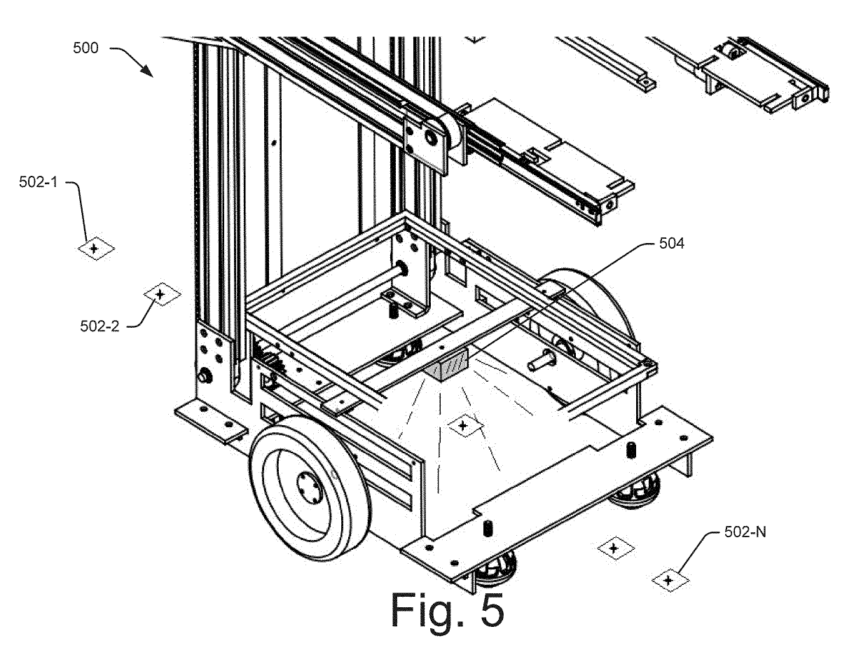

The vision guidance and navigation unit 112 enables the RDU 100 to navigate through the warehouse. The vision guidance and navigation unit 112 enables the navigation by scanning features present in the warehouse. The features can include, but are not restricted to, objects, text, symbols, codes, stickers, and patterns, on, for example, the floor, the wall, or the ceiling of the warehouse. In an implementation, the vision guidance and navigation unit 112 can include a camera which can capture the landmarks. The landmark information may then be communicated to the processor 102 for determining a direction for navigation. The vision guidance and navigation unit 112 can also include a global positioning system (GPS) that captures accurate three dimensional location. In an implementation, the vision guidance and navigation unit 112 determines the location of the RDU 100 based on surroundings of the RDU 100, such as inventory racks, storage units, and last storage unit at which an action has been executed. The navigation of the RDU 100 will be explained in greater detail with reference to FIG. 5.

The communication device 114 communicates with the computing device for receiving information, such as a task, and sending information, such as position of the RDU 100, amount of inventory on the RDU 100, and completion of a task by the RDU 100. In an implementation, the communication device 114 is a wireless communication device with Wi-Fi functionality.

The I/O device 116 includes an input device, such as a keyboard and a touch sensitive display, which facilitates a user to interface with the RDU 100. The I/O device 116 can also include a display to display information related to ongoing tasks and actions, pending tasks, and other information related to the RDU 100.

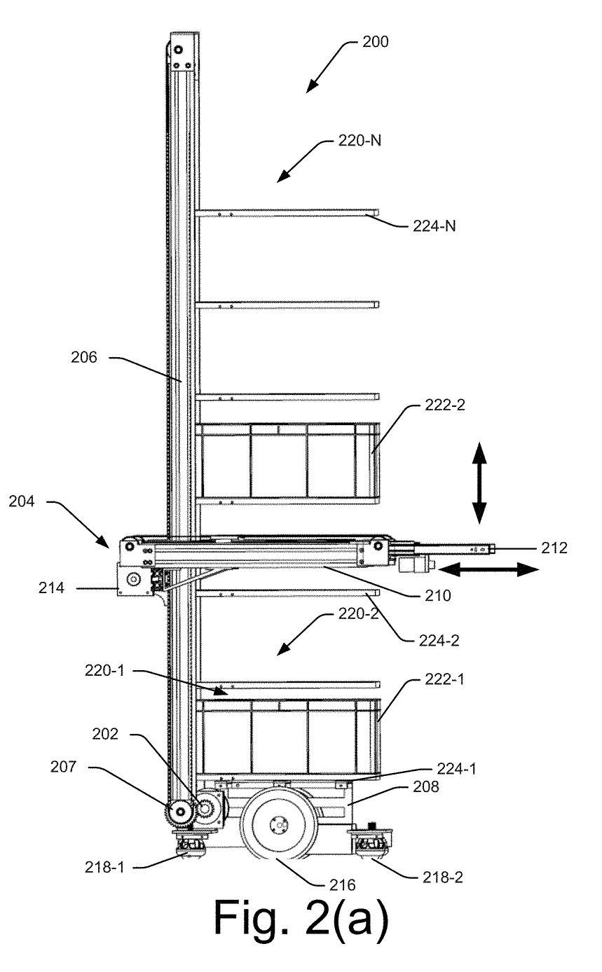

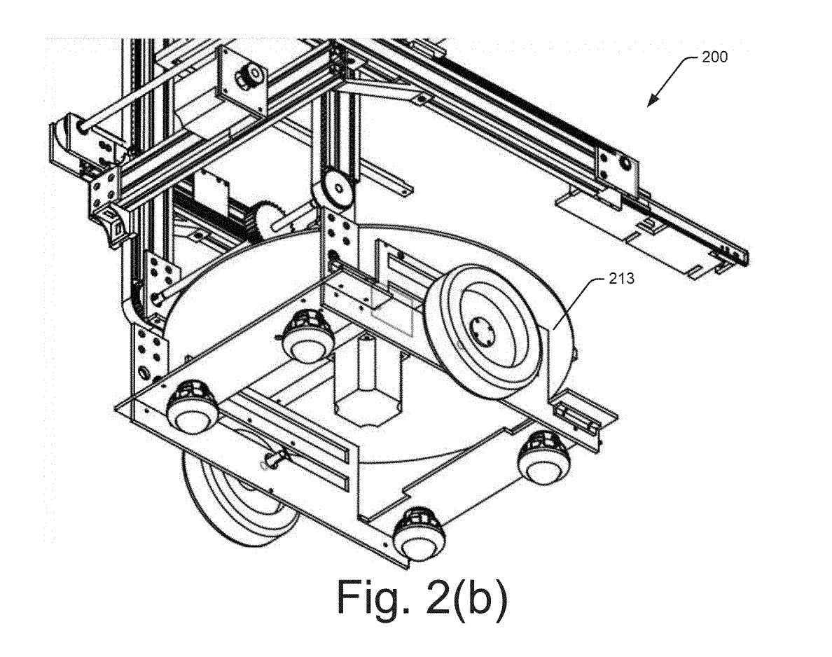

FIG. 2(a) illustrates an RDU 200, in accordance with an implementation of the present subject matter. The RDU 200 may be similar to the RDU 100. The RDU 200 includes an arm positioner 202 that adjusts position of an arm unit 204 in a vertical plane. The arm positioner 202 enables the arm unit 204 to be moved along arm supporting structure 206, as illustrated by two thick arrows pointing upwards and downwards, for positioning the arm holder 204 in the vertical plane. In an example, the arm positioner 202 can position the arm unit 204 near a shelf in an inventory rack, which enables storing or retrieving products in the shelf.

As illustrated in FIG. 2(a), the arm positioner 202 can include a motor which is coupled to the arm unit 204 through pulley 207 and another pulley at the top of the RDU 200 (not shown in Fig.). The arm positioner 202 can be mounted on chassis 208 of the RDU 200.

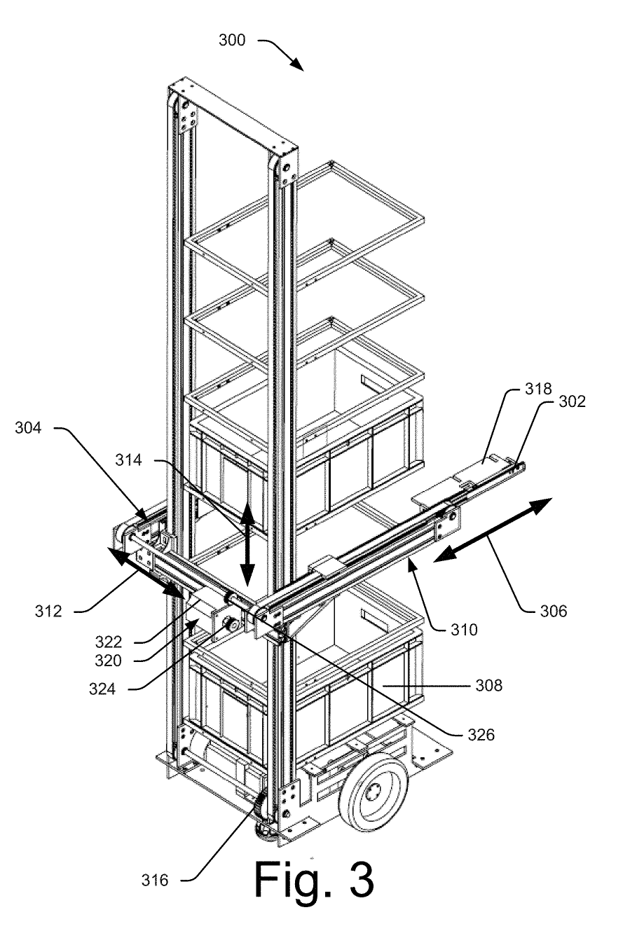

The arm unit 204 includes an arm that further includes a base arm 210 and an extendable arm 212, which is housed in the base arm 210. The extendable arm 212 can be extended and retracted, as illustrated by two thick horizontal arrows, which enables retrieving and storing the products, for example, in the shelf of in the inventory rack. When extended, the extendable arm 212 extends beyond the chassis 208 of the RDU 200. The extendable arm 212 can include holders for firmly holding and lifting the products. The extension and retraction of the extendable arm 212 from the base arm 210 can be controlled using an arm extender 214. The operation of the arm extender 214 will be explained in greater detail with reference to FIG. 3.

In an implementation, the arm supporting structure 206 is rotatable 360° relative to the chassis 208. The rotation of the supporting structure 206 enables horizontally positioning the arm for storing and retrieving the products without rotating the entire RDU 200. The rotation of the supporting structure is illustrated in FIG. 2(b).

As illustrated in FIG. 2(b), the RDU 200 can include a rotary plate 213 on which inventory to be rotated for storing in a location is placed, and rotated by a motor (not shown in Fig.). In another implementation, the extendable arm 212 can traverse behind the arm supporting structure 206 in the horizontal plane to reach inventory racks behind the arm supporting structure 206. In an implementation, the traversal behind the arm supporting structure 206 can be effected by rotating the arm unit 204 which can be rotated by 360° relative to the arm supporting structure 206. In another implementation, the traversal can be effected by retracting the extendable arm 212 such that it extends behind the arm supporting structure 206.

Referring back to FIG. 2(a), the RDU 200 traverses along the warehouse using a drive wheel 216. The drive wheel 216 may be powered by a drive unit, similar to the drive unit 104, which, in turn, can be controlled by a processor (not shown in Fig.), which is similar to the processor(s) 102. The processor can be placed near the chassis 208. In addition to the processor, the RDU 200 can include an additional processor (not shown in Fig.) on its top. The additional processor can be utilized for communication with the computing system. The drive wheel 216 can be balanced and supported by one or more caster wheels, such as caster wheels 218-1 and 218-2.

The RDU 200 includes a storage space in which plurality of products can be carried. In an implementation, the storage space includes one or more compartments 220-1, 220-2 . . . , 220-N, in which products, such as products 222-1 and 222-2 can be accommodated for their storage and retrieval. The storage space can be divided into the compartments 220-1, 220-2, 220-3, and 220-4 by dividers 224-1, 224-2 . . . and 224-N. Although the RDU 200 is shown as having seven compartments, it will be understood that the RDU 200 can have more or fewer compartments.

The presence of multiple compartments in the RDU 200 enables storing multiple products in the RDU 200 for fulfilling orders. In an example order for which five products have to be retrieved, all products can be retrieved by the RDU 200 and delivered to warehouse personnel in a single shot, unlike a conventional RDU having a single compartment, which performs retrieval and delivery actions five times, one for each product. Thus, using the RDUs of the present subject matter, storage and retrieval operations are considerably faster. The multiple compartments may be offset to be parallel to the axis of the arm vertical movement in case of rotatable arm unit 204 or rotatable supporting structure 206.

In an implementation, the RDU 200 rearranges the products 222 among the compartments 220. The rearrangement can be performed to enable storing a product retrieved from a shelf in the inventory rack. For example, if a product is to be retrieved from a shelf that is at a height of the compartment 220-1, and the compartment 220-1 is occupied with the product 222-1, the RDU 200 can relocate the product 220-1 to another compartment, say compartment 220-2, which is vacant. The RDU 200 can then retrieve the product to be retrieved from the shelf and store it in the compartment 220-1. The manner in which the rearrangement is performed will be explained in detail with reference to FIG. 3. The rearrangement of the products in the RDU 200 enables the RDU 200 to collect multiple products before reaching a destination location for delivery of the products. This is because, if multiple products which are in shelves at the same height are to be retrieved for an order, the RDU 200 can rearrange products in its compartments to retrieve all the products. In case of a rotatable arm unit 204 or rotatable arm supporting structure 206, the products can be directly relocated to another compartment without removing the existing inventory item in a compartment.

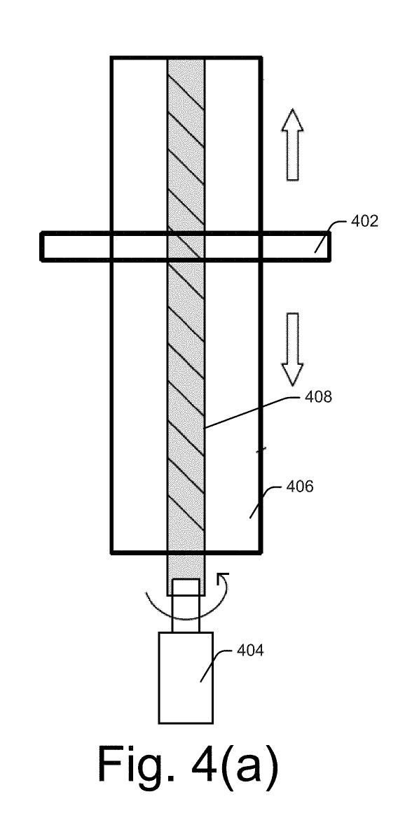

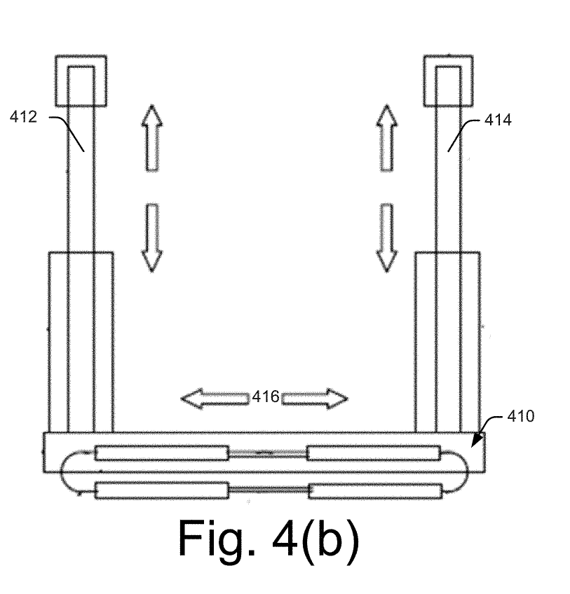

FIG. 3 illustrates a three dimensional view of an RDU 300, in accordance with an implementation of the present subject matter. The RDU 300 may be similar to the RDU 100 and the RDU 200. The RDU 300 includes two arms. One arm includes extendable arm 302 and another arm includes extendable arm 304 (parallel to the extendable arm 304 on other side of the RDU 300), similar to the extendable arm 212, which are extendable in the direction shown by arrows 306 to store and retrieve products, such as product 308, in a shelf of an inventory rack. Further, the two arms, of arm unit 310 (similar to the arm unit 204), can be moved horizontally in the direction shown by arrows 312 for holding the products of different shapes and sizes. The movement in the direction of arrows 312 can be effected using a horizontal arm positioner (not shown in Fig.) The horizontal arm positioner is explained with reference to FIG. 4(b).

Similarly, vertical movement in a direction 314 of the arm unit 310 to retrieve the product from different levels of shelves is achieved using arm positioner 316, similar to the arm positioner 202.

The vertical movement in the direction 314 can be used for rearranging products among compartments in the RDU 300. In an implementation, the rearrangement of a product among compartments can be performed by bringing the arm unit 310 to the level of the compartment from which a product is to be relocated, holding the product using holders 318 of the extendable arms 302 and 304, extending the extendable arms 302 and 304, moving the arm unit 310 in the direction 312 towards a vacant compartment to which the product is to be relocated, retracting the extendable arms 302 and 304 once the arm unit 310 reaches the level of the vacant compartment, and finally, loosening the holders 318, so that the product can be placed on the vacant compartment. Although the rearrangement is explained in an implementation where the RDU 300 includes multiple compartments, however, the rearrangement is possible in an implementation of the RDU 300 without the multiple compartments. In accordance with the implementation, multiple products are stacked on top of each other, which are relocated by the arm unit 310.

The extension and retracting of the extendable arms 302 and 304 enable vertical movement of a product in the RDU 300 without disturbance to the compartments. In an implementation, the extension and retraction is achieved using an arm extender 320, similar to the arm extender 214. The arm extender 320 includes a motor 322 and a pulley 324 that is coupled the shaft of the motor 322. The pulley 324 is further coupled to pulley 326 through a belt (not shown in Fig.). The rotation of the motor 322 is translated to the extension and retraction motion of the extendable arms 302 and 304 by the pulleys 324 and 326.

FIG. 4(a) illustrates vertical movement of an arm holder 402 of an arm unit, in accordance with an implementation of the present subject matter. The arm holder 402 is used to hold a base arm similar to the base arm 210. As illustrated, the arm holder 402 is coupled to a motor shaft 404. The rotation of the motor shaft 404 translates into a linear motion of the arm holder 402 in an upward and downward direction along an arm supporting structure 406. In an implementation, the translation of the rotary motion to the linear motion can be effected by means of a ball screw mechanism 408. In other implementations, the translation can be effected by means of pulleys, gears, or a rack and pinion arrangement.

FIG. 4(b) illustrates horizontal movement of arms of an RDU using horizontal arm positioner, in accordance with an implementation of the present subject matter. A horizontal arm positioner 410 includes a slider coupling to enable extendable arms 412 and 414 to extend forward or backward towards the product or container. In other words, the horizontal arm positioner 410 enables the extendable arms 412 and 414 to move towards and away from each other. The slideable movement of the extended arms is represented by arrows 412.

The RDUs can navigate in a warehouse for various storage and retrieval operations. The navigation of an RDU will now be explained in greater detail with reference to FIG. 5.

FIG. 5 illustrates navigation of an RDU 500, in accordance with an implementation of the present subject matter. For assisting the navigation of the RDU 500, the floor or the warehouse includes a plurality of stickers 502-1, 502-2, . . . . 502-N. The plurality of stickers forms part of the features, which were explained with reference to the description of FIG. 1. To scan the plurality of stickers, the RDU 500 includes a sensor, such as a camera 504. Instead of a camera, the sensor can be a laser positioner, a sound signal positioner, or data transmission positioners, which helps the RDU 500 to locate itself in a warehouse. As explained earlier, the scanned information can be sent to the processor of the RDU 500 by a vehicle guidance and navigation unit, similar to the vehicle guidance and navigation unit 112. Based on the received scanned information, the processor can determine a direction to move in. The processor can determine the direction to move in based on instructions received from the computing system. The instructions received from the computing system can be based on the number of stickers scanned. For example, the instructions can be “travel straight until 10 stickers are scanned, then take a right and travel straight till 20 stickers are scanned, and then travel left for 5 stickers”.

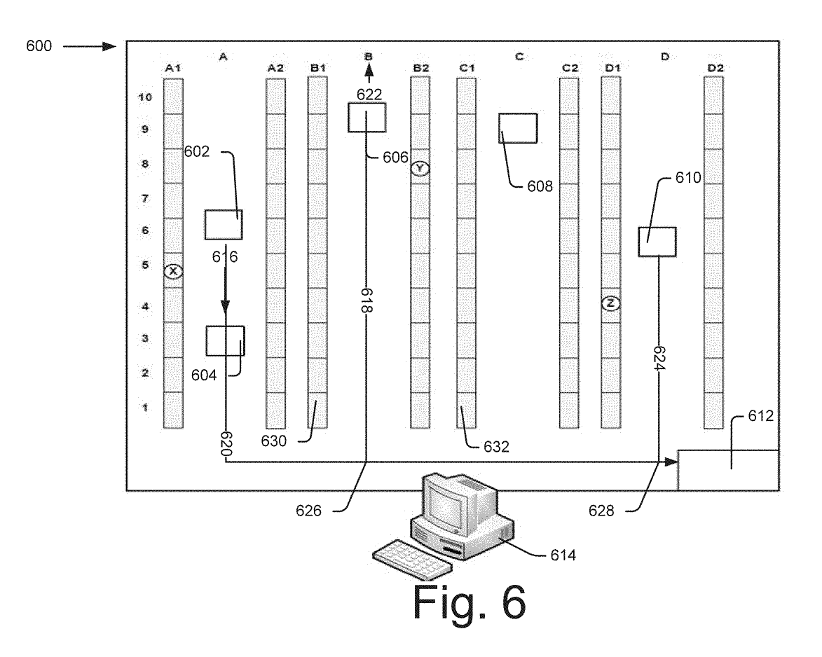

FIG. 6 illustrates an example warehouse 600 in which multiple RDUs are used for storage and retrieval operations, in accordance with an implementation of the present subject matter. The warehouse 600 includes multiple inventory racks A1, A2, B1, B2, C1, C2, D1, and D2. The inventory racks A1-D2 include multiple storage levels, each of which includes multiple shelves (not shown in the Fig.) for storage of products. Each inventory rack is divided into storage units 1 to 10 for identification of a product location. For performing the storage and retrieval operations in response to an order, multiple RDUs, RDUs 602, 604, 606, 608, and 610, are utilized in the warehouse 600. Although the warehouse 600 is shown to have five RDUs, it will be understood that the warehouse 600 can include any number of RDUs. The warehouse 600 may include a destination location 612 where warehouse personnel can receive retrieved products from the RDUs 602-610, or can provide products to the RDUs 602-610 for storage in the warehouse 600. The destination location 612 may also be a location outside the warehouse 600. The warehouse 600 may also include a plurality of destination locations.

For controlling the RDUs 602-610 for the storage and retrieval operations, a computing system 614 is utilized. The computing system 614 includes processor(s), an order receiving module, an RDU assignment module, and an intersection point module (not shown in Fig.).

The computing system 614 accepts orders related to storage and retrieval operations from an authorized user and performs one or more operations accordingly. The authorized user may be warehouse personnel. To fulfill the order using the RDUs 602-610, the computing system 614 stores warehouse inventory location data, which can include, but is not restricted to, product details, such as product identification number, product name, brand, and quantity, storage information of a product, such as product container identifier (ID), storage unit number, storage level, shelf ID, and inventory rack ID, and location information of the product. The computing system 614 communicates with the RDUs 602-610 using any known communication technology, such as Wi-Fi, to assign tasks and to keep track of execution of tasks.

The warehouse 600 may have multiple products stored at different locations. When an order for products is retrieved by the computing system 614, the products corresponding to the order are to be retrieved from the locations they are stored in. For this, the computing system 614 assigns the order as a task to an RDU, which then executes the assigned task. The task includes multiple actions, which can include, but are not restricted to, navigating to a shelf in the warehouse 600 at which a product to be retrieved is stored and retrieving the product from the shelf. Further, the task includes information about the product to be retrieved, which can include, but is not restricted to, product name, product ID, ID of a container that carries the product, storage unit number, storage level number, inventory rack ID.

In addition to the above information, to enable the RDU to navigate to the shelf in in which the product to be retrieved is stored, the computing system 614 communicates location information of the shelf to the RDU. The location information is sent as part of the task. In an implementation, the computing system 614 can communicate the location information as three dimensional coordinates of the shelf. In another implementation, the computing system 614 can send the location information as instructions explained in the description of FIG. 5. The manner in which the computing system 614 communicates the location information can be based on capabilities of vision guidance and navigation unit of the RDU. For example, if the vision guidance and navigation unit includes a GPS, which can navigate based on received three dimensional location information, the computing system 614 communicates the location information in the form of three dimensional coordinates of the shelf. Similarly, if the RDU includes a camera similar to the camera similar to the camera 504, the computing system 614 can send instructions in the form of number of stickers to be scanned in each direction. In an implementation, the location information includes checkpoints en route to the product and a destination point.

For retrieving products from multiple locations in the warehouse 600 or for storing products to multiple locations, the computing system 614 can optimize the movement of the RDUs in such a way that the total time taken for completing the storage or retrieval operation is reduced. The optimization by the computing system 614 will now be explained with the help of an example scenario in which three products, products X, Y, and Z, have to be retrieved from three different locations in the warehouse 600 and then delivered to the destination point 612. Although the example scenario is explained with the help of retrieval of three products, it will be understood that the optimization can be extended to retrieval of a plurality of products.

In accordance with the example scenario, initially, the computing system 614 identifies the locations of all the RDUs 602-610 in the warehouse 600. The identification of the location can be performed using, for example, information received from a vehicle guidance and navigation unit, such as the vehicle guidance and navigation unit 112, in the RDUs 602-610. The information can be received from the RDUs by the RDU communication module.

Then, the order receiving module receives an order for which three products, products X, Y, and Z, are to be retrieved from the warehouse 600.

Thereafter, the RDU assignment module assigns a task of delivery of the three products, products X, Y, and Z, to the first RDU 602. As explained earlier, the tasks assigned by the computing system 614 includes actions to be performed by the first RDU 602. In accordance with this example, the actions include the following:

Action 1: retrieve the product X from storage unit 5 of inventory rack A1,
Action 2: retrieve the product Y from storage unit 8 of inventory rack B2, and
Action 3: retrieve the product Z from the storage unit 4 of inventory rack D1.

In addition to the action information, the task includes the shelf and inventory rack information for the products X, Y, and Z. Further, task also includes the location information of the shelves in which the products X, Y, and Z are stored are also communicated to the first RDU 602 by the computing device 614. Here, a single storage level, i.e., one shelf per storage unit is shown for simplifying the illustration. However, the each storage unit can include multiple storage levels, i.e., multiple shelves. Accordingly, the storage level information can be specified in the action.

Upon the assignment of the task to the first RDU 602, the RDU assignment module analyzes, for each of the three products, whether retrieval of the product is to be performed by an RDU other than the first RDU 602. In other words, the RDU assignment module analyzes for each of the products X, Y, and Z whether retrieval of the product is to be performed by any of the RDUs 604-610. For the analysis, the RDU assignment module utilizes one or more conditions. In an implementation, the one or more conditions include, but are not restricted to, distance of an RDU other than the first RDU 602 (RDUs 604-610) from each product, availability of vacant compartments in the RDU other than the first RDU, future path of the RDU other than the first RDU, and vacancy of a shelf nearest to the intersection point of the first RDU 602 and the RDU other than the first RDU.

The one or more conditions will now be explained in greater detail. Regarding the first condition, i.e., the distance of an RDU other than the first RDU from each product, the RDU assignment module compares the distance of the first RDU 602 from each product to be retrieved with distance of other RDUs (604-610) from the product. For example, the RDU assignment module compares the distance of first RDU 602 from the product X with the distance of other RDUs 604-610 from the product X. If the first RDU 602 is found closer to the product than any other RDU, the RDU assignment module 614 determines that first RDU 602 can be used retrieve the product. For example, since first RDU 602 is closest to the product X, the RDU assignment module can determine that first RDU 602 has to retrieve the product X. However, if the RDU assignment module determines that an RDU other than first RDU 602 is closer to a product, the RDU assignment module can consider the other RDU for the retrieval. For example, when the RDU assignment module performs the distance calculations for the product Y, it determines that RDU 606 is closest to the product Y. Similarly, the computing system 614 determines that RDU 610 is nearest to the product Z.

Regarding the second of the one or more conditions (availability of vacant compartments in the RDU other than the first RDU), the RDU assignment module determines if an RDU other than the first RDU 602 has a vacant compartment or not. If the RDU is found to have a vacant compartment, the RDU assignment module considers the RDU for the task of retrieval of the product.

Regarding the third condition (future path of the RDU other than the first RDU) the RDU assignment module analyzes future path of each RDU. Every RDU in the warehouse 600 has its own task of delivery assigned to it. In other words, each RDU has the task of delivering some products to a destination location. The destination location for an RDU can be same as, or different from the destination location 612. For this, the RDU can take a path to the destination location. The path taken by the RDU 606 is illustrated by the dotted line 618, which extends from the RDU 606 to the destination location 612. For an RDU to be able to retrieve a product to be delivered by the first RDU 602, a future path, i.e., a path to be taken by an RDU to reach the destination location 612, of that RDU and the first RDU 602 have to coincide. For example, the future path of the RDU 606 is 618, which coincides the future path 620 of the first RDU 602. If, however, the future path of the RDU 606 was starts in the direction as indicated by the arrow 622, the future path of the RDU 606 may not coincide with the future path of the first RDU 602. Thus, the RDU assignment module considers an RDU for retrieving a product to the delivered by the first RDU 602 if its future path coincides with that of the first RDU's. Further, the RDU assignment module also determines whether a product to be retrieved in the future path of an RDU. For example, the RDU assignment module considers the RDU 606 for retrieving the product Y when the product Y is in the future path of the RDU 606. Since the future path 618 of the RDU 606 has the product Y in it, the RDU 606 can be considered for retrieving the product Y. Similarly, the RDU assignment module considers the RDU 610 for retrieving the product Z, as its future path 624 coincides with the future path 620 of the first RDU 602 and has product Z on it.

Regarding the fourth condition (vacancy of a shelf nearest to the intersection point of the first RDU 602 and the RDU other than the first RDU), since the RDUs 606 and 610 have to deliver the products retrieved by them to the first RDU 602 the RDUs 606 and 610 can deliver the products Y and Z at an intersection of their future paths with the future path of the first RDU 602. For example, the RDU 606 can deliver the product Y at a point 624 that is at an intersection of future path 620 of the first RDU 602 and the future path 618 the RDU 606. Similarly, the RDU 610 can deliver the product Z at a point 628 that is at an intersection of the future path 620 of the first RDU 602 and the future path 624 of the RDU 610. The point at the intersection of the future paths of the two RDUs, i.e., first RDU 602 and 606 or first RDU 602 and 610, is hereinafter referred to as an intersection point. The intersection point is determined by the intersection point module.

Even though the RDU 606 (or 610) can deliver the product Y (or Z) at their respective intersection points 626 (or 628), if the RDU 606 (or 610) arrives at the intersection point 626 (or 628) much earlier than the first RDU 602, the RDU 606 (or 610) will have to wait at the intersection point 626 (or 628) for the arrival of the first RDU 602. The delay in arrival of the first RDU 602 at the intersection point 626 (or 628) can be because of traffic on its future path or larger distance from its location to the intersection point 626 (or 628) compared to the distance of the location of the RDU 606 (or 610) from the intersection point 626 (or 628). For example, with regard to the intersection point 628, the distance of the first RDU 602 from the intersection point 628 is much larger compared to the distance of the RDU 610 from the intersection point 628. Therefore, RDU 610 may have to wait for a significant time at the intersection point 628. This may lead to a reduction in the optimization.

To prevent the reduction in optimization, the computing system 614 computes the difference in the arrival times of the first RDU 602 and the RDU other than the first RDU (606 or 610) to reach at their intersection point (626 or 628). If the difference exceeds a threshold time, the computing system 614 concludes that a reduction in optimization might occur. In an example, the threshold time is 20 seconds.

If the difference at an intersection point is within the threshold time, the computing system 614 determines that there is not a significant deterioration in optimization, and instructs the RDU whose future path intersects the future path of the first RDU to deliver the products it retrieved to the first RDU 602 at the intersection point. The products retrieved by an RDU, for example, product Y, retrieved by the RDU 606 and product Z retrieved by the RDU 610, will be referred to as its respective retrieved products. The intersection point module instructs the RDU, such as RDUs 606 and 610, by communicating an updated task the RDUs with include the location information of the intersection point and the action to be performed at the intersection point, such as deliver the product. Similarly, the intersection point module instructs the first RDU 602 to retrieve the respective retrieved product from the intersection point by communicating an updated task to the first RDU 602 having the location information of the intersection point and an action to retrieve the product. Accordingly, the RDUs execute the tasks they received from the computing system 614. As will be understood, the updated task communicated to the first RDU 602 will not include the location information of the shelf having the product Y or product Z, as the first RDU 602 need not go to those shelves to retrieve the products Y and Z. Further, it will be understood that the instructions to deliver at the intersection point in case of RDUs 606 and 610 and instructions to retrieve at the intersection point will be provided for each intersection point of the first RDU 602.

If, however, it is determined that the product Y or Z retrieved by the RDU 606 or 610 can be placed at the nearest shelf to their respective intersection points, from where the first RDU 602 can retrieve it once it arrives to the nearest shelf. The nearest shelf can be shelf 630 for the RDU 606 and shelf 632 for the RDU 610. However, the product Y or Z can be placed at the nearest shelf only if it is vacant. Therefore, if the arrival time difference exceeds the threshold time, and if the nearest shelf to the intersection point is not vacant, the computing system 614 determines that the RDU cannot be used to retrieve the product.

Based on the above description, it can be seen that based on the analysis of the one or more conditions, the task of retrieval of the products Y and Z are assigned to the RDUs 606 and 610 respectively. Similarly, based on the analysis of one or more conditions for a plurality of products to be retrieved for an order, the task of retrieval of one or more products of the plurality of products can be assigned to one or more RDUs other than the first RDU 602.

Once the nearest shelf is identified, the computing system 614 instructs the RDUs 606 or 610 by sending updated tasks to the RDU 606 or 610 that can include location information of the nearest shelf and action to be performed at the nearest shelf, i.e., storage of the product Y or Z.

Thereafter, once the RDU 606 or 610 completes storing of the product at the nearest shelf, the RDU updates the computing system 614 of the completion. The computing system 614 then sends an updated task to the first RDU 602 including the location information of the nearest shelf and an action of retrieving the product from the nearest shelf. It can be seen that in case the time difference exceeds the threshold time, the nearest shelf, when vacant, can act as the intersection point. Thus, in this case, the nearest shelf also acts as the intersection point.

In an implementation, the computing system 614 includes a network adapter (not shown in Fig.) to communicate with the RDUs in the warehouse 600. Through the network adapter, the computing system 614 can receive location information of the RDUs, and also communicate tasks of delivery and retrieval to the RDUs. The communication with the RDUs through the network adapter can be performed by the communication module. The computing system 614 tracks location of the RDUs based on the received location information. Based on the tracking, the computing system 614 can then monitor traffic in any location in the warehouse 600. The traffic information can be used by the computing system 614 to predict arrival time of any RDU at any point in its future path. The prediction can be used for assigns the tasks of retrieval and delivery to an RDU. It can also be used to cancel assignment of a task if it is determined that the RDU may take more than to arrive at the point.

In an implementation, similar to the RDU 606, which retrieves product Y and delivers to first RDU 602 for completion of an order, the first RDU 602 can retrieve products that are to be delivered by the RDU 606. In such a case, at the intersection point 626, the first RDU 602 indulges in a product exchange with the RDU 606, i.e., it receives the product Y from the RDU 606 and delivers the product it retrieved for the RDU 606.

As explained earlier, the computing system 614 can control the RDUs 602-610 for optimizing a storage scenario also. An example storage scenario can include transfer of the three products by a first RDU 602 from the destination location 612 to three different locations. Accordingly, the optimization can include identification of other RDUs that intersect the path of the first RDU 602 and that travel towards any of the three locations, determination whether the delivery from the first RDU 602 to another RDU will be direct or indirect (by placing in a nearest shelf), and carrying of the transferred products by the other RDUs to the location in which the products are to be stored.

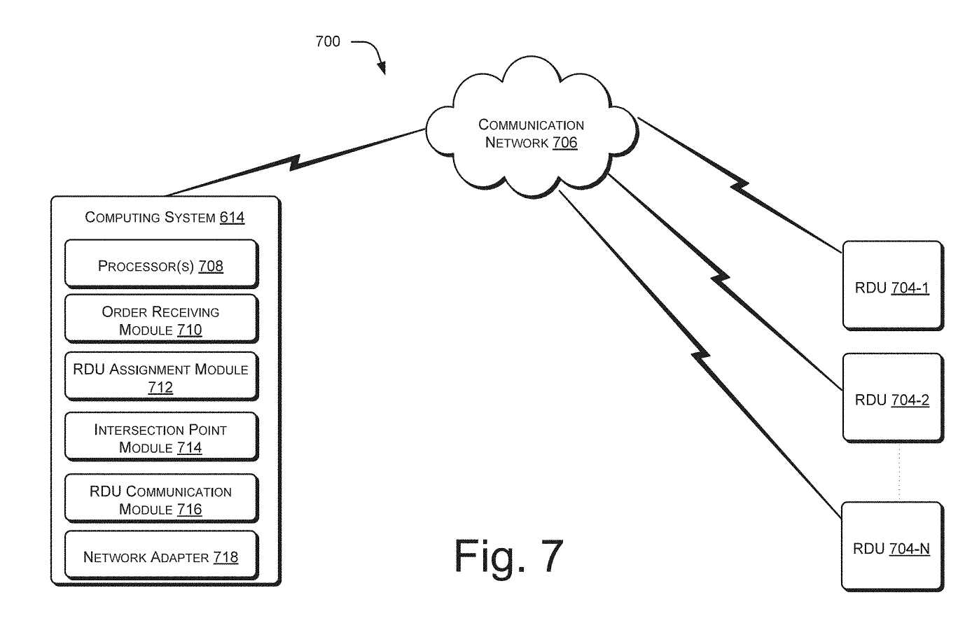

FIG. 7 illustrates a schematic representation of a network environment of a warehouse, in accordance with an implementation of the present subject matter. The warehouse may be similar to the warehouse 600. The network environment 700 may either be a public distributed environment or may be a private closed network environment. The network environment 700 includes the computing system 614, a first RDU 704-1, a second RDU 704-2, . . . n^{th} RDU 704-N through a communication network 706.

The communication network 706 may be a wireless or a wired network, or a combination thereof. The communication network 706 may be a collection of individual networks, interconnected with each other and functioning as a single large network (e.g., the internet or an intranet). Examples of such individual networks include, but are not restricted to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 706 includes various network entities, such as transceivers, gateways, and routers; however, such details have been omitted for ease of understanding.

As explained earlier, the computing system 614 includes a processor 708, an order receiving module 710, an RDU assignment module 712, an intersection point module 714, an RDU communication module 716, and a network adapter 718. Further, the computing system 614 may also include interface(s), memory, other modules, and system data, which are not shown in Fig.

The computing system 614 may be implemented as any computing system which may be, but is not restricted to, a server, a workstation, a desktop computer, a laptop, a smartphone, a personal digital assistant (PDA), a tablet, a virtual host, and an application. The server or computing system 614 may also be a RDU hosting a network. The computing system 614 may also be a machine readable instructions-based implementation or a hardware-based implementation, or a combination thereof.

The order receiving module 710, RDU assignment module 712, the intersection point module 714, the communication module 716, and the other modules may be coupled to and/or be executable by the processor(s) of the computing system 614, and may include, amongst other things, routines, programs, objects, components, data structures, and the like, which perform particular tasks or implement particular abstract data types. The other modules may include programs or coded instructions that supplement applications and functions, for example, programs in the operating system, of the computing system 614. Though explained as separate modules, it will be understood that in other implementations, the order receiving module 710, the RDU assignment module 712, the intersection point module 714, and the communication module 716 may be implemented as a part of the same module.

The interface(s) may include a variety of machine readable instructions-based interfaces and hardware interfaces that allow interaction with a user and with other communication and computing devices, such as network entities, web servers, and external repositories, and peripheral devices. The memory may include any non-transitory computer-readable medium including, for example, volatile memory (e.g., RAM), and/or non-volatile memory (e.g., EPROM, flash memory, Memristor, etc.). The memory may also be an external memory unit, such as a flash drive, a compact disk drive, an external hard disk drive, or the like.

The system data may serve as a repository for storing data that may be fetched, processed, received, or created by the order receiving module 710, the RDU assignment module 712, the intersection point module 714, the RDU communication module, and the other modules or received from connected computing systems and storage devices.

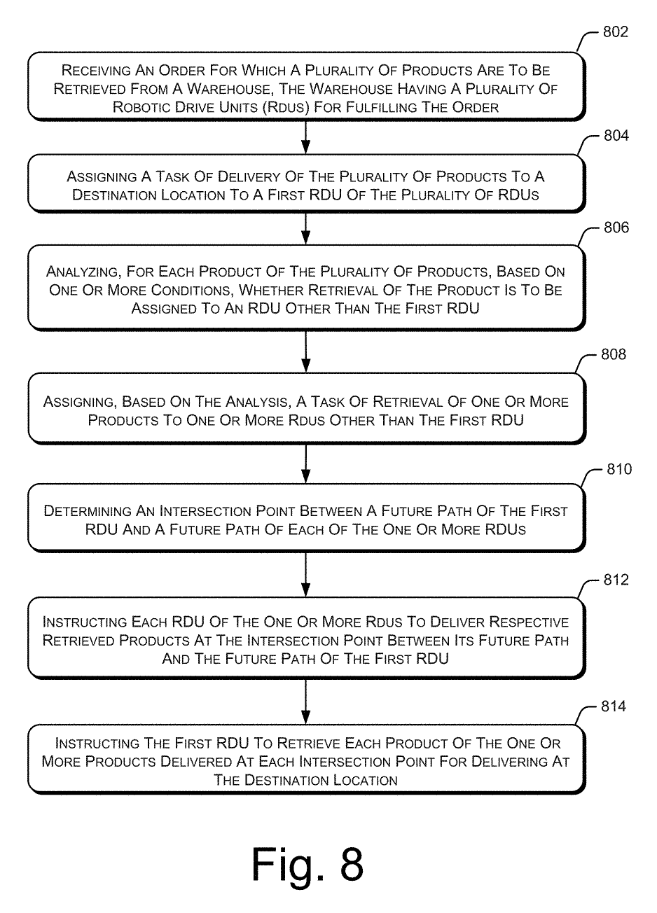

FIG. 8 illustrates a method 800 and utilized by the computing system 614 for optimizing a retrieval operation, in accordance with an implementation of the present subject matter.

The order in which the method 800 is described is not intended to be construed as a limitation, and any number of the described method blocks may be combined in any order to implement the method 800, or an alternative method. Furthermore, the method 800 may be implemented by processor(s) or computing device(s) through any suitable hardware, non-transitory machine readable instructions, or a combination thereof.

It may be understood that steps of the method 800 may be performed by programmed computing devices and may be executed based on instructions stored in a non-transitory computer readable medium. The non-transitory computer readable medium may include, for example, digital memories, magnetic storage media, such as one or more magnetic disks and magnetic tapes, hard drives, or optically readable digital data storage media. Further, although the method 800 may be implemented in a variety of systems; the method 800 is described in relation to the aforementioned computing system 614, for ease of explanation.

At block 802, an order for which a plurality of products are to be retrieved from a warehouse is received. The warehouse has a plurality of RDUs for fulfilling the order.

At block 804, a task of delivery of the plurality of products to a destination location is assigned to a first RDU of the plurality of RDUs.

At block 806, an analysis is performed, for each product of the plurality of products, based on one or more conditions, whether retrieval of the product is to be assigned to an RDU other than the first RDU.

At block 808, based on the analysis, a task of retrieval of one or more products is assigned to one or more RDUs other than the first RDU.

At block 810, an intersection point between a future path of the first RDU and a future path of each of the one or more RDUs is determined.

At block 812, each RDU of the one or more RDUs is instructed to deliver respective retrieved products at the intersection point between its future path and the future path of the first RDU.

Finally, at block 814, the first RDU is instructed to retrieve each product of the one or more products delivered at each intersection point for delivering at the destination location.

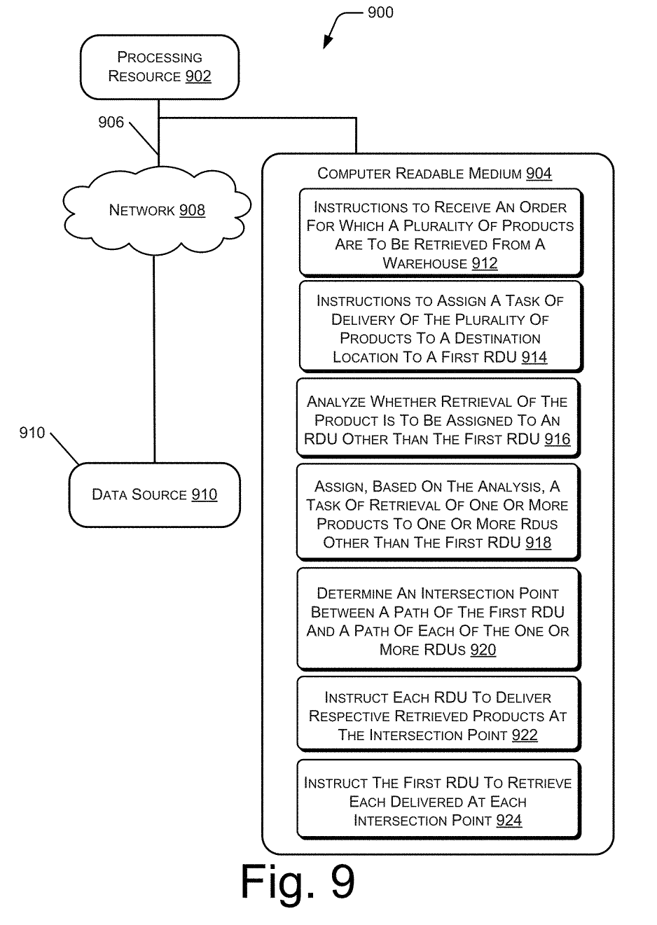

FIG. 9 illustrates a network environment 900, according to an example implementation of the present subject matter. The network environment 900 includes processing resource(s) or processor(s) 902 of a network entity communicatively coupled to a non-transitory computer readable medium 904 through a communication link 906. In an example, the processor(s) 902 may have one or more processing resources for fetching and executing computer-readable instructions from the non-transitory computer readable medium 904. The processor(s) 902 may be a processor of a network entity in the network environment 900.

The non-transitory computer readable medium 904 can be, for example, an internal memory device or an external memory device. In an example implementation, the communication link 906 may be a direct communication link, such as any memory read/write interface. In another example implementation, the communication link 906 may be an indirect communication link, such as a network interface. In such a case, the processor(s) 902 can access the non-transitory computer readable medium 904 through a network 908. The network may be a single network or a combination of multiple networks and may use a variety of different communication protocols.

The processor(s) 902 and the non-transitory computer readable medium 904 may also be communicatively coupled to data source 910 over the network. The data source 910 can include, for example, source devices and destination devices.

In an example implementation, the non-transitory computer readable medium 904 includes a set of computer readable instructions to enable verification of functionality restrictions of a computing device, such as the computing device 614. The set of computer readable instructions can be accessed by the processor(s) 902 through the communication link 906 and subsequently executed to perform acts to enable verification of the functionality restrictions of the computing device.

Referring to FIG. 9, in an example, the non-transitory computer readable medium 904 includes instructions 912 that cause the processor(s) 902 to receive an order for which a plurality of products are to be retrieved from a warehouse, the warehouse having a plurality of robotic drive units (RDUs) for fulfilling the order.

The non-transitory computer readable medium 904 includes instructions 914 that cause the processor(s) 902 to assign a task of delivery of the plurality of products to a destination location to a first RDU of the plurality of RDUs.

The non-transitory computer readable medium 904 includes instructions 916 that cause the processor(s) 902 analyze, for each product of the plurality of products, based on one or more conditions, whether retrieval of the product is to be assigned to an RDU other than the first RDU.

The non-transitory computer readable medium 904 includes instructions 918 that cause the processor(s) 902 assign, based on the analysis, a task of retrieval of one or more products to one or more RDUs other than the first RDU.

The non-transitory computer readable medium 904 includes instructions 920 that cause the processor(s) 902 determine an intersection point between a path of the first RDU and a path of each of the one or more RDUs.

The non-transitory computer readable medium 904 includes instructions 922 that cause the processor(s) 902 instruct each RDU of the one or more RDUs to deliver respective retrieved products at the intersection point between its path and the path of the first RDU.

Further, the non-transitory computer readable medium 904 includes instructions 924 that cause the processor(s) 902 instruct the first RDU to retrieve each product of the one or more products delivered at each intersection point for delivering at the destination location.

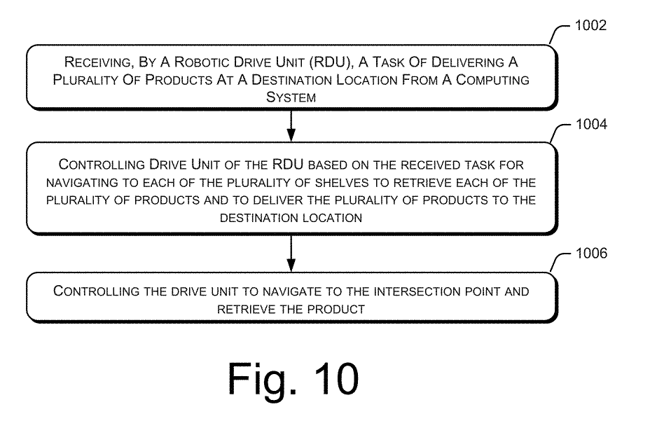

FIG. 10 illustrates a method 1000 for utilizing a robotic drive unit (RDU) to deliver a plurality of products to a destination location, in accordance with implementation of the present subject matter.

At block 10002, an RDU receives a task of delivering a plurality of products at a destination location from a computing system. The task includes actions of retrieving a plurality of products from a plurality of shelves in a warehouse and location information of the plurality of shelves;

At block 1004, a drive unit of the RDU is controlled based on the received task for navigating to each of the plurality of shelves to retrieve each of the plurality of products and to deliver the plurality of products to the destination location.

When the communication device receives an updated task including location information of an intersection point from which the RDU is to retrieve a product of the plurality of products and action of retrieving the product from the new shelf, at block 1006, the drive unit is controlled to navigate to the intersection point and retrieve the product. The intersection point is a point of intersection of future path of the RDU with future path of another RDU that is to deliver the product of the plurality of products at the intersection point.

Although the present subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter.

What is claimed is:

1. A method comprising:
receiving an order for which a plurality of products are to be retrieved from a warehouse, the warehouse having a plurality of robotic drive units (RDUs) for fulfilling the order;
assigning a task of delivery of the plurality of products to a destination location to a first RDU of the plurality of RDUs;
analyzing, for each product of the plurality of products, based on one or more conditions, whether retrieval of the product is to be assigned to an RDU other than the first RDU;
assigning, based on the analysis, a task of retrieval of one or more products to one or more RDUs other than the first RDU;
determining an intersection point between a future path of the first RDU and a future path of each of the one or more RDUs;
instructing each RDU of the one or more RDUs to deliver respective retrieved products at the intersection point between its future path and the future path of the first RDU; and
instructing the first RDU to retrieve each product of the one or more products delivered at each intersection point for delivering at the destination location.

2. The method as claimed in claim 1, wherein the one or more conditions comprises distance of an RDU other than the first RDU from each product, availability of vacant compartments in the RDU other than the first RDU, vacancy of a shelf nearest to the intersection point of the first RDU and the RDU other than the first RDU, and the future path of the RDU other than the first RDU.

3. The method as claimed in claim 2, wherein the analyzing comprises comparing, for each product, distance of the RDU other than the first RDU from the product with distance of the first RDU from the product.

4. The method as claimed in claim 2, wherein the analyzing comprises determining whether the RDU other than the first RDU comprises a vacant compartment.

5. The method as claimed in claim 2, wherein the analyzing comprises determining whether a product of the plurality of products is in the future path of the RDU other than the first RDU and whether the future path of the RDU other than the first RDU intersects with the future path of the first RDU.

6. The method as claimed in claim 2, wherein the intersection point comprises nearest shelf to the intersection point when the nearest shelf is vacant.

7. The method as claimed in claim 6 comprising:
determining difference in arrival times of the first RDU and an RDU of the one or more RDUs at their intersection point;
determining the nearest shelf to the intersection point if the difference exceeds a threshold time;
instructing the RDU of the one or more RDUs to deliver the respective retrieved products to the nearest shelf; and
instructing the first RDU to retrieve the respective retrieved products from the nearest shelf.

8. The method as claimed in claim 1 comprising:
tracking location of each of the plurality of RDUs;
monitoring traffic in a location of the warehouse based on the tracking; and
predicting arrival time of each of the plurality of RDUs at a location in its future path based on the traffic for at least one of assigning a task of delivery to the RDU, assigning a task of retrieval to the RDU, cancelling the assignment of task of delivery to the RDU, and cancelling the assignment of the task of retrieval to the RDU.

9. A computing system comprising:
an order receiving module to receive an order for retrieving a plurality of products from the warehouse, the warehouse having a plurality of robotic drive units (RDUs) for fulfilling the order;
an RDU assignment module to:
assign a task of delivery of the plurality of products to a destination location to a first RDU;
analyze, for each product of the plurality of products, based on one or more conditions, whether retrieval of the product is to be assigned to an RDU other than the first RDU; and
assign, based on the analysis, a task retrieval of one or more products to one or more RDUs other than the first RDU; and
an intersection point module to:
determine, for each RDU of the one or more RDUs, an intersection point between its path and path of the first RDU;
instruct each RDU of the one or more RDUs to deliver respective retrieved products at the intersection point between its path and the path of the first RDU; and
instruct the first RDU to retrieve each product of the one or more products delivered at each intersection point for delivering at the destination location.

10. The computing system as claimed in claim 9, wherein the one or more conditions comprises distance of an RDU other than the first RDU from each product, availability of vacant compartments in the RDU other than the first RDU, vacancy of a shelf nearest to the intersection point of the first RDU and the RDU other than the first RDU, and the future path of the RDU other than the first RDU.

11. The computing system as claimed in claim 9, wherein the task of delivery of the plurality of products comprises actions of retrieving a plurality of products from a plurality of shelves in the warehouse and location information of the plurality of shelves the first RDU has to navigate to for retrieving the plurality of products.

12. The computing system as claimed in claim 9, wherein, to instruct each RDU of the one or more RDUs, the intersection point module is to communicate an updated task having location information of the intersection point to each RDU of the one or more RDUs.

13. The computing system as claimed in claim 9, wherein the intersection point comprises nearest shelf to the intersection point when the nearest shelf is vacant, and wherein the intersection point module is to:
determine difference in arrival times of the first RDU and an RDU of the one or more RDUs at their intersection point;
determine the nearest shelf to the intersection point if the difference exceeds a threshold time;
instruct the RDU of the one or more RDUs to deliver the respective retrieved products to the nearest vacant shelf; and
instruct the first RDU to retrieve the respective retrieved products from the nearest shelf.

14. The computing system as claimed in claim 9 comprising:
a network adapter to communicate with each of the plurality of RDUs; and
an RDU communication module to:
receive location information of each of the plurality of RDUs through the network adapter; and
communicate the task of delivery and the task of retrieval through the network adapter.

15. A non-transitory computer-readable medium comprising instructions for optimizing movement of robotic drive units (RDUs), the instructions being executable by a processor to:
receive an order for which a plurality of products are to be retrieved from a warehouse, the warehouse having a plurality of robotic drive units (RDUs) for fulfilling the order;
assign a task of delivery of the plurality of products to a destination location to a first RDU of the plurality of RDUs;
analyze, for each product of the plurality of products, based on one or more conditions, whether retrieval of the product is to be assigned to an RDU other than the first RDU;
assign, based on the analysis, a task of retrieval of one or more products to one or more RDUs other than the first RDU;
determine an intersection point between a path of the first RDU and a path of each of the one or more RDUs;
instruct each RDU of the one or more RDUs to deliver respective retrieved products at the intersection point between its path and the path of the first RDU; and
instruct the first RDU to retrieve each product of the one or more products delivered at each intersection point for delivering at the destination location.

16. A robotic drive unit (RDU) to deliver a plurality of products to a destination location, the RDU comprising:
a drive unit to drive the RDU;
a communication device to receive a task of delivering a plurality of products at a destination location from a computing system, the task comprising actions of retrieving a plurality of products from a plurality of shelves in a warehouse and location information of the plurality of shelves;
a processor to control the drive unit based on the received task for navigating to each of the plurality of shelves to retrieve each of the plurality of products and to deliver the plurality of products to the destination location, wherein when the communication device receives an updated task from the computing system, the updated task comprising location information of an intersection point from which the RDU is to retrieve a product of the plurality of products and action of retrieving the product from the new shelf, the processor controls the drive unit to navigate to the intersection point and retrieve the product, and wherein the intersection point is a point of intersection of future path of the RDU with future path of another RDU that is to deliver the product of the plurality of products at the intersection point.

17. The RDU as claimed in claim 16 comprising:
a storage space to carry the plurality of products;
an arm unit comprising at least one arm to hold a product of the plurality of products and an arm holder to hold the at least one arm;
an arm positioner to move the at least one arm vertically;
an obstacle detection unit to detect objects in a future path of the RDU; and
a vision guidance and navigation unit to enable the RDU to navigate along the warehouse.

18. The RDU as claimed in claim 16, wherein the drive unit comprises a drive wheel and one or more caster wheels.

19. The RDU as claimed in claim 17, wherein the storage space comprises a plurality of compartments each of which can accommodate a product of the plurality of products.

20. The RDU as claimed in claim 17, wherein the at least one arm comprises two arms and wherein the arm unit comprises a horizontal arm positioner to move the two arms towards and away from each other in a horizontal plane.

21. The RDU as claimed in claim 20, wherein the at least one arm comprises a base arm and an extendable arm that is housed in the base arm, the extendable arm being extendable and retractable from the base arm.

22. The RDU as claimed in claim 21, wherein the extendable arm comprises a holder to hold a product of the plurality of products.

23. The RDU as claimed in claim 22, comprising an arm extender to extend and retract the extendable arm, wherein
the arm extender is to extend the extendable arm when the extendable arm holds a product to be relocated;
the arm positioner is to move the arm unit vertically upwards or downwards towards a vacant compartment to which the product is to be relocated;
the arm extender is to retract the extendable arm when the arm unit reaches level of the vacant compartment for storing the product to be relocated in the vacant compartment.

24. The RDU as claimed in claim 17 comprising an arm supporting structure on which the arm unit is mounted and along which the arm unit is movable in a vertical plane.

25. The RDU as claimed in claim 24, wherein the arm supporting structure is rotatable by 360° relative to chassis, and wherein the arm unit is at least one of rotatable by 360° relative to the arm supporting structure and retractable behind the arm supporting structure of the RDU for horizontally positioning the arm for storing and retrieving the products without rotating the entire RDU.

26. The RDU as claimed in claim 17, wherein the vision guidance and navigation unit comprises a sensor to scan stickers on floor of the warehouse for enabling navigation of the RDU.

27. The RDU as claimed in claim 16, wherein the communication device sends updates to the computing system upon completion of a task.

28. The RDU as claimed in claim 17, wherein the vision guidance and navigation unit scans features present in the warehouse, the features comprising at least one of objects, text, symbols, codes, stickers, and patterns, on, at least one of the floor, the wall, the ceiling of the warehouse.

29. A method for utilizing a robotic drive unit (RDU) to deliver a plurality of products to a destination location, the method comprising:
receiving, by the RDU, a task of delivering a plurality of products at a destination location from a computing system, the task comprising actions of retrieving a plurality of products from a plurality of shelves in a warehouse and location information of the plurality of shelves;
controlling a drive unit of the RDU based on the received task for navigating to each of the plurality of shelves to retrieve each of the plurality of products and to deliver the plurality of products to the destination location,
wherein when the communication device receives an updated task from the computing system, the updated task comprising location information of an intersection point from which the RDU is to retrieve a product of the plurality of products and action of retrieving the product from the new shelf, and
controlling the drive unit of the RDU to navigate to the intersection point and retrieve the product, and wherein the intersection point is a point of intersection of future path of the RDU with future path of another RDU that is to deliver the product of the plurality of products at the intersection point.

30. The method as claimed in claim 29 comprising rearranging a product from a compartment in the RDU to a vacant compartment to which the product is to be relocated, wherein the rearranging comprises:
bringing an arm unit of the RDU to a level of a compartment from which the product is to be relocated;
holding the product using holders of extendable arms of the RDU;
extending the extendable arms, the extending enabling the extendable arms to extend beyond chassis of the RDU;
moving the arm unit in a direction towards the vacant compartment;
retracting the extendable arms once the arm unit reaches a level of the vacant compartment; and
loosening the holders, so that the product can be placed on the vacant compartment.
